(19) United States
(12) Patent Application Publication
(10) Pub. No.: US 2018/0261991 A1
(43) Pub. Date: Sep. 13, 2018

(54) A BUSBAR ASSEMBLY

(71) Applicant: General Electric Technology GmbH, Baden (CH)

(72) Inventor: Jerome GREGOIRE, Stafford (GB)

(21) Appl. No.: 15/759,834

(22) PCT Filed: Sep. 5, 2016
(86) PCT No.: PCT/EP2016/070870

§ 371 Date: Mar. 14, 2018

(30) Foreign Application Priority Data
Sep. 15, 2015 (GB) 1516309.0

(51) Int. Cl. H02G 5/10; H02M 7/00

(52) U.S. Cl. CPC H02G 5/10; H02M 7/003

(57) ABSTRACT

There is disclosed a busbar assembly including a busbar having one or more conductor layers for electrical conduction, and an electrically conductive heat transfer line configured to convey a cooling fluid therethrough, where the heat transfer line is thermally and electrically coupled to a conductor layer of the busbar so that in use there is no voltage difference between the heat transfer line and the respective conductor layer of the busbar.

### FIELD OF THE INVENTION

The invention relates to a busbar assembly.

### BACKGROUND

Busbars are typically used in a number of industries for electrically connecting components, particularly where there is a large current and/or voltage load. One example use of busbars is in HVDC (high-voltage direct current) electrical power transmission and conversion equipment.

HVDC electrical power transmission uses direct current for the transmission of electrical power. This is an alternative to alternating current electrical power transmission which is more common. There are a number of benefits to using HVDC electrical power transmission. HVDC is particularly useful for power transmission over long distances and/or interconnecting alternating current (AC) networks that operate at different frequencies.

Increasingly, voltage source converters (VSCs) are being proposed for use in HVDC transmission. VSCs use switching elements such as Insulated Gate Bipolar Transistors (IGBTs) that can be controllably turned on and turned off independently of any connected AC system. In one form of VSC, known as a module multilevel converter (MMC), each valve connecting an AC terminal to a DC terminal comprises a series of sub-modules (or cells) connected in series, each sub-module comprising an energy storage element, such as a capacitor, and a switch arrangement that can be controlled so as to either connect the energy storage element in series between the terminals of the sub-module or bypass the energy storage element. The sub-modules of a valve are controlled to connect or bypass their respective energy storage element at different times so as to vary over time the voltage difference across the valve. By using a relatively large number of sub-modules and timing the switching appropriately the valve can synthesise a stepped waveform that approximates to a sine wave and which contains low levels of harmonic distortion.

An example sub-module comprises a laminated busbar having at least a positive plate, a negative plate and an AC (alternating current) plate. An energy storage element in the form of a capacitor is connected to a terminal on the busbar, and two switching elements such as IGBTs are coupled to terminals on the busbar in a half-bridge arrangement. A busbar is used owing to the high current load through the sub-module, which in this example may be up to 2000 A (Ampere), and is laminated to minimize inductance. In other examples, the current load may be higher.

However, as the power rating of new HVDC VSCs increases, the equipment is placed under increasing electrical loading. The high electrical loading can lead to high thermal loading in the busbar, capacitor, IGBTs and the connectors between them. The thermal loading is caused by ohmic losses (thermal power dissipation) within the conductive material of the busbar and the connectors (or terminals) between components. For example, the busbar may reach up to 100° C. during operation.

It is therefore desirable to dissipate heat away from the busbar, which may be done using a fluid cooling arrangement.

Further, it is desirable to design a busbar assembly to be compact so as to reduce both its inductance (i.e. for efficiency and thermal loading concerns), and for installation. However, a compact arrangement of the busbar assembly can make heat dissipation from the busbar more difficult.

Insufficient cooling of a busbar can adversely affect its operation, or result in limitations on the system in which it is installed. In the example of laminated busbars for use in power converter modules, it is desirable to limit the inductance of the conductive layers of the busbar to reduce semiconductor switching losses, and this can be achieved by placing the conductive layers in close proximity (i.e. in adjacent layers) separated by an insulator plate, which serves to limit the electric field interaction between adjacent conductor plates. The or each insulator plate may comprise Glass Reinforced Plastic (GRP) or a ceramic material, for example.

A thin film layer composed of an insulator material may also be provided on the outside surfaces of the conductive layers, and held on the conductive layers by a thermoactive glue. The film layer, may increase the creepage distance and electrically insulate the conductors. Typical thin film layers may comprise an electrically insulating material such as polyethylene terephthalate (PET). However, the durability, insulating and mechanical properties of such thin film insulators are typically dependent on temperature.

Since the mechanical integrity and insulating performance of the thin film insulators must be maintained, the thin film insulators may effectively place an upper operational limit on the temperature of the busbar, and thereby an operational limit on the current-carrying capacity of the busbar assembly. This could result in the current-rating of a sub-module or other equipment being limited based on the performance of the busbar.

Accordingly, it is desirable to provide an improved busbar assembly.

### SUMMARY

According to a first aspect of the invention there is provided a busbar assembly comprising: a busbar comprising one or more conductor layers for electrical conduction; and an electrically conductive heat transfer line configured to convey a cooling fluid therethrough, wherein the heat transfer line is thermally and electrically coupled to a conductor layer of the busbar so that in use there is no voltage difference between the heat transfer line and the respective conductor layer of the busbar.

There may be no insulating material between the heat transfer line and a cooling fluid received therein.

The heat transfer line may be mechanically coupled to the conductor layer. The heat transfer line may be directly mechanically coupled to the conductor layer. The heat transfer line may be directly mechanically coupled to the conductor layer by braising or welding such that the heat transfer line is continuous with the conductor layer. The braising or welding join may form at least part of an electrically conductive pathway between the conductor layer of the busbar and the heat transfer line.

The heat transfer line may be mechanically coupled to the conductor layer by a mechanical fastener, and the fastener may form at least part of an electrically conductive pathway between the conductor layer of the busbar and the heat transfer line. The fastener may directly couple the conductor layer and a flange of the heat transfer line. The mechanical fastener may be selected from one of the group consisting of a rivet, stud, screw or bolt.

The heat transfer line may be held against the busbar by a retaining element mechanically and electrically coupled to the conductor layer of the busbar. Where there is an electrical pathway between the heat transfer line and the conductor layer which does not extend through the retaining element, the retaining element may be non-conductive. The retaining element may extend around the opposite side of the heat transfer line to the side held against the busbar.

The retaining element may be electrically conductive and may be made of a material having an electrical conductivity of at least 10⁵ S/m (10⁻⁵ Ohm.m).

The mechanical fastener may extend between the conductor layer and the retaining element. The retaining element may be in the form of a curved plate. In other words, the retaining element may be in the form of a moulded sheet-like material, such as a curved or bent sheet of copper.

The heat transfer line may be in the form of a pipe. The heat transfer line may be composed of an electrically conductive material having an electrical conductivity of at least 10⁵ S/m, for example stainless steel (1.45*10⁶ S/m) or aluminium (4.5*10⁷ S/m). The heat transfer line may be composed of a thermally conductive material having a thermal conductivity of at least 12 W/(m.k).

The retaining element may be composed of an electrically conductive material having an electrical conductivity of at least 10⁵S/m. The retaining element may be composed of a thermally conductive material having a thermal conductivity of at least 12 W/(m.k). The retaining element may be composed of aluminium or stainless steel.

The busbar assembly may further comprise: a film layer composed of an insulating material disposed between at least a portion of the heat transfer line and the respective conductor layer, and an electrical pathway extending through or around the film layer between the heat transfer line and the respective conductor layer. The respective conductor layer for a heat transfer line is that to which the heat transfer line is thermally and electrically coupled

Where the busbar assembly comprises a retaining element, there may be a film layer composed of an insulating material between at least a portion of the retaining element and the respective conductor layer, and there may be an electrical pathway extending through or around the film layer between the heat transfer line and the conductor layer. The electrical pathway may be formed by a mechanical fastener extending between the conductor layer and the retaining element or heat transfer line. The electrical pathway may be formed by a connection between the conductor layer and a portion of the retaining element or heat transfer line where there is no intervening film layer, for instance, a connection formed by the retaining element or heat transfer line being held against or joined (e.g. by braising or welding) to the conductor layer, or by a mechanical fastener.

The heat transfer line may be coupled to an electrically insulating conduit for attachment to a fluid cooling network, such that in use the conduit electrically insulates the heat transfer line from the fluid cooling network.

The busbar assembly may further comprise a fluid cooling network, and wherein the heat transfer line is coupled to the fluid cooling network to receive a cooling fluid from the cooling network. The heat transfer line may be coupled to the fluid cooling network via one or more electrically insulating conduits, such that in use the heat transfer line is electrically insulated from the fluid cooling network. The electrically insulating (non-conductive) conduits may have a conductivity of less than 10⁻⁶S/m. The conduits may comprise flexible hoses. The conduits may be composed of Polyurethane, Polyethylene or Crosslinked polyethylene (conductivity of 10⁻⁸ S/m), rubber (conductivity of 10⁻¹⁴ S/m) or Teflon (conductivity of 10⁻²³ S/m). The fluid network may contain an electrically insulating cooling fluid. The cooling fluid may be a non-conductive fluid. The cooling fluid may be deionized. The cooling fluid may be a dielectric cooling fluid. The cooling fluid may comprise deionized water or a deionized water glycol mixture. The cooling fluid may be liquid or gas. The cooling fluid may have an electrical conductivity of less than 2*10⁻⁴ S/m.

There may be a plurality of heat transfer lines thermally and electrically coupled to the conductor layer. A plurality of heat transfer lines thermally and electrically coupled to the same conductor layer may be arranged in series or parallel. The busbar may comprise a plurality of conductor layers. There may be a plurality of heat transfer lines, each heat transfer line being thermally and electrically coupled to one conductor layer only, and at least two conductor layers may be thermally and electrically coupled to respective heat transfer lines.

The plurality of conductor layers may comprise at least a first conductor layer and a second conductor layer which are electrically insulated from one another, and the or each heat transfer line electrically coupled with the first conductor layer may be electrically insulated from the or each heat transfer line electrically coupled with the second conductor layer. Each conductor layer of the busbar may be electrically insulated from each other conductor layer. The busbar assembly may further comprise an insulator plate disposed between the conductor layers to electrically insulate them from one another.

The insulator plate may have a thickness of between 1 mm and 5 mm. In contrast, a film layer composed of insulating material may have a thickness of between 0.1 and 0.3 mm.

The or each heat transfer line electrically coupled with each respective conductor layer may be electrically insulated from any heat transfer lines electrically coupled with other conductor layers of the busbar that are electrically insulated from the respective conductor layer. The busbar may be a laminated busbar comprising a plurality of conductive layers electrically insulated from each other.

The or each heat transfer line may not be laminated to or with the busbar.

The busbar assembly may be for a power converter module. The busbar assembly may form part of a sub-module for a power converter, and/or part of a module of a power converter, such as a voltage source converter.

According to a second aspect of the invention there is provided a sub-module for a power converter comprising: a busbar assembly according to the first aspect of the invention; and a switching element electrically coupled to the busbar of the busbar assembly.

The sub-module may comprise a heatsink for the switching element, and the or each heat transfer line of the busbar assembly may be fluidically coupled to the heatsink. The heatsink may form part of any fluid network for conveying cooling fluid.

According to a third aspect of the invention there is provided a method of power conversion using a sub-module for a power converter in accordance with the second aspect of the invention, wherein an electrically insulating cooling fluid is provided to the or each heat transfer line.

### BRIEF DESCRIPTION OF THE DRAWINGS

The invention will now be described, by way of example, with reference to the drawings, in which:

FIG. 1 schematically shows a perspective view of a sub-module for a power converter;

FIG. 2 schematically shows a cross-sectional view of the sub-module of FIG. 1;

FIGS. 3 and 4 schematically show perspective views of the busbar of FIG. 1;

FIG. 5 schematically shows a cross-sectional view of a further sub-module;

FIG. 6 schematically shows a cross-sectional view of a sub-module showing detail of a busbar and cooling arrangement; and

FIG. 7 schematically shows a cross-sectional view of a portion of a sub-module showing detail of a busbar and cooling arrangement.

### DETAILED DESCRIPTION

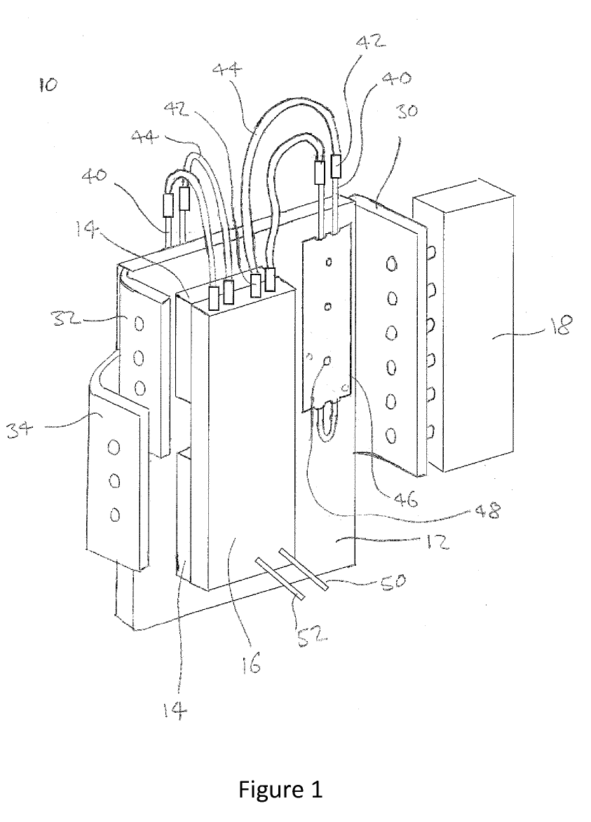

FIGS. 1-4 show a sub-module 10 for a power converter including a laminated busbar 12, two switching elements 14 mounted on the busbar 12, a cooling plate 16 mounted on the switching elements, and a capacitor 18 coupled to terminals of the busbar 12. The busbar 12 is provided with a cooling arrangement to form a busbar cooling assembly or “busbar assembly”.

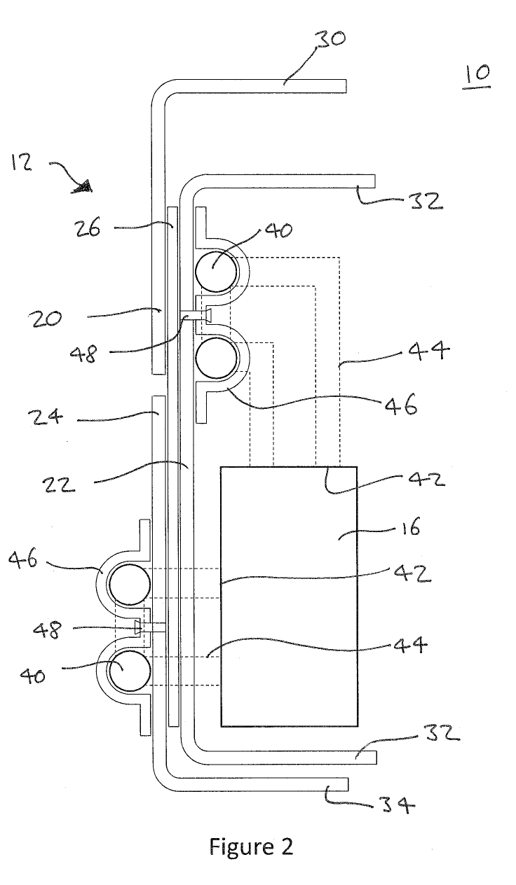

The laminated busbar 12 comprises three conductor plates or layers 20, 22, 24, including a positive layer 20, a negative layer 22 and an output layer 24 (as best shown in FIG. 2). Each conductor layer is composed of copper and is approximately 1-3 mm thick, although in other embodiments different conductor materials (such as aluminium) and thicknesses may be used.

FIG. 2 shows a partial cross-sectional view of the sub-module 10 omitting several components for clarity (e.g. the switching elements 14 and capacitor 18). As shown in FIG. 2, one of the conductor layers (the negative layer 22) forms a first layer of the busbar 12. The negative layer 22 has a substantially planar portion and two terminal portions 30 which are bent away from the planar portion, as will be described below, such that is has a substantially C-shaped cross-section. The busbar 12 further comprises an insulator plate 26 forming a second layer of the busbar 12 coupled to the rear side of the first layer (the left side in FIG. 2) and having substantially the same planar extent as the planar portion of the negative layer 22 (the first layer of the busbar). On the rear side of the insulator plate 26, the positive plate 20 and output plate 24 are arranged in a non-overlapping configuration to form a third layer of the busbar 12. Accordingly, the insulator layer 26 is sandwiched between the negative plate 22, and the positive and output plates 20, 24 together. Each of the conductor layers may also be provided with a thin film layer of insulating material (not shown), as will be described in detail below.

Each conductor layer is provided with a terminal portion 30, 32, 34 which is continuous with the respective conductor layer, but in this embodiment, is bent away from a main planar portion of the busbar 12. Each terminal portion 30, 32, 34 comprises a series of terminals for coupling with components of the sub-module, such as the capacitor 18, as best shown in FIG. 1.

In this embodiment the insulator plate 26 disposed between the conductor plates 20, 22, 24 is composed of Glass Reinforced Plastic (GRP) and has a thickness substantially the same as the conductor plates 20, 22, 24. In other embodiments, the insulator plate 26 may be composed of different materials and have a different thickness from the conductor plates.

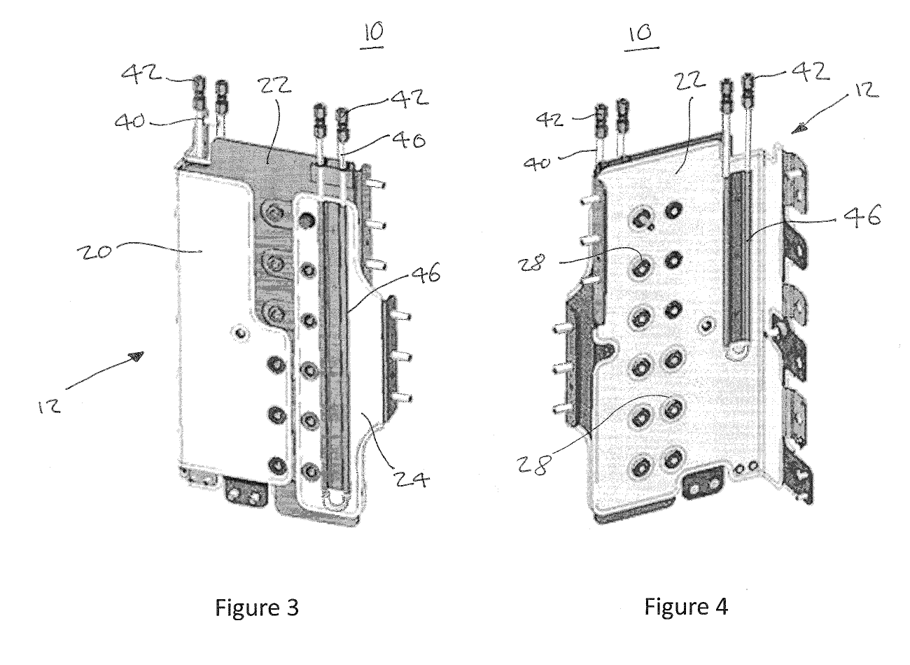

As shown in FIGS. 3 and 4, each conductor plate 20, 22, 24 also has a series of terminals 28 for connecting with corresponding terminals of the switching elements 14. In this embodiment, the switching elements 14 are Insulated Gate Bipolar Transistors (IGBTs).

The sub-module further comprises two heat transfer lines 40 coupled to two respective conductor layers 22, 24 of the busbar 12 and configured to convey a cooling fluid therethrough to cool the conductor plates in use. In this embodiment, a first transfer line 40 is coupled to the negative conductor layer 22, and a second transfer line 40 is coupled to the output conductor layer 24. In this embodiment, the heat transfer lines 40 comprise aluminium pipes having a diameter of approximately 6 mm and a wall thickness of approximately 1 mm leaving a central channel for conveying cooling fluid having a diameter of approximately 4 mm. The pipes have a substantially circular cross-section.

In this embodiment, each heat transfer line 40 comprises two parallel line portions extending along the surface of the respective conductor layer 22, 24 and joined by an integral curved line portion having a U-shape (towards the lower end of the busbar 12 in FIGS. 1, 3 and 4). The parallel line portions each extend beyond the edge of the respective conductor layer 22, 24 and are each coupled to connectors 42, for example by threading. In this embodiment the connectors 42 are made of conductive stainless steel or aluminium. In other embodiments, different materials could be used, such as polyvinylidene fluoride (PVDF) or Acrylonitrile butadiene styrene plastic (ABS), and the material selection may depend on the cooling fluid for use with the sub-module. In other embodiments, electrically insulating connectors can be used.

A flexible hose 44, which in this embodiment is composed of electrically insulating polyethylene, extends from each connector 42 to a further connector 42, which is coupled to a port of the cooling plate 16. Accordingly, there is no electrical conduction from the cooling plate 16 to the heat transfer line along the hoses 44. The two heat transfer lines 40 are coupled, via the hoses and connectors 42, 44 to parallel ports of the cooling plate 16 such that there is a parallel (rather than series) relationship between the flows in the respective heat transfer lines 40.

In this embodiment, the heat transfer lines 40 are coupled to the respective conductor layers 20, 24 using an electrically conductive retaining plate 46 composed of stainless steel (although other materials may be used) that is curved to conform to the profile of the pipes lying over the surfaces of the conductor layers. Accordingly, the retaining plate 46 has flat portions either side of the heat transfer line 40 and between the respective parallel line portions, and convexly curved retaining portions configured to extend around the respective line portions. In another embodiment, there may only be one flat portion between the pipes and none on either side.

In this embodiment, the retaining plate 46 extends along a substantial length of the heat transfer line (e.g. approximately 75% of the length of the heat transfer line 40 along the respective conductor layer), but in other embodiments the retaining plate 46 may have a different extent (e.g. longer or shorter), and/or may comprise discrete retaining plate portions distributed along the length of the heat transfer line. Further, in other embodiments the heat transfer line 40 may extend along any suitable path along the respective conductor layer, such as a curved or wavy path, and there may not be parallel line portions. The retaining plate 46 or other retaining element may be designed accordingly to retain the heat transfer line 40 against the busbar 12 so that they are thermally coupled.

An electrically conductive fastener 48, in this embodiment a screw composed of zinc-plated steel (such as hardened steel or heat-treated carbon steel) is inserted through the retaining plate 46 and into the respective conductor layer so as to electrically couple the respective conductor layer with the retaining plate 46, and thereby the associated heat transfer line 40. Accordingly, in use there is no voltage difference between the heat transfer line and the respective conductor layer. In this embodiment, there are three screws 48 spaced along the length of the plate 46 between the two parallel line portions of the heat transfer line.

Accordingly, the respective fasteners 48 and retaining plate 46 form an electrical pathway from each heat transfer line 40 to the respective conductor layer 22, 24. In this embodiment, the respective retaining plate 46 is also in direct electrical contact with the respective conductor layer and with the associated heat transfer line 40, and each heat transfer line 40 is also in direct electrical contact with the conductor layer itself. However, in other embodiments, there may be a film layer composed of insulating material between at least a portion of the heat transfer line 40 and/or any retaining plate 46 and the respective conductor layer, as will be described in detail below.

In use, the sub-module 10 is coupled to other sub-modules 10 to form a power converter and the switching elements are controlled to convert power from alternating current to direct current or vice versa.

To cool the busbar 12 in use, a cooling fluid is provided to the heat transfer lines 40. The cooling fluid is received through an inlet line 50 to the cooling plate 16 from a cooling source (not shown), and is returned to the cooling source through an outlet line 52. The inlet line 50 and outlet line 52, together with internal channels within the cooling plate 16, form part of a fluid network for conveying cooling fluid to be received in the heat transfer lines 40. The cooling network may extend across multiple sub-modules 10.

In this embodiment, the cooling fluid is deionized water glycol mixture which is an electrically insulating fluid having a conductivity of less than 2*10⁻⁴ S/m. The cooling fluid is received from the cooling network at a temperature of approximately 53° C. and is conveyed through the cooling plate 16 to cool the IGBTs 14. Subsequently, the cooling fluid is distributed to outlet ports of the cooling plate 16 to be conveyed to each heat transfer line 40. For each heat transfer line 40, the cooling fluid is conveyed from the cooling plate 16, through a connector 42, inlet flexible hose 44, further connector 42, and through the heat transfer line 40. Having flowed through the heat transfer line 40, the fluid is conveyed through a connector 42, outlet flexible hose 44, further connector 42 and back into a manifold within the cooling plate 16.

The cooling fluid is received in the heat transfer line 40 at a temperature lower than the operational temperature of the busbar 12 (or at least the respective conductor layer of the busbar), and so the effect of conveying the cooling fluid through the heat transfer line is that heat is transferred from the respective conductor layer to the heat transfer line. In the embodiment described above and shown in FIGS. 1-4, the heat is transferred directly from the respective conductor layer to the heat transfer line, and is also transferred indirectly via the screw 48 and retaining plate 46.

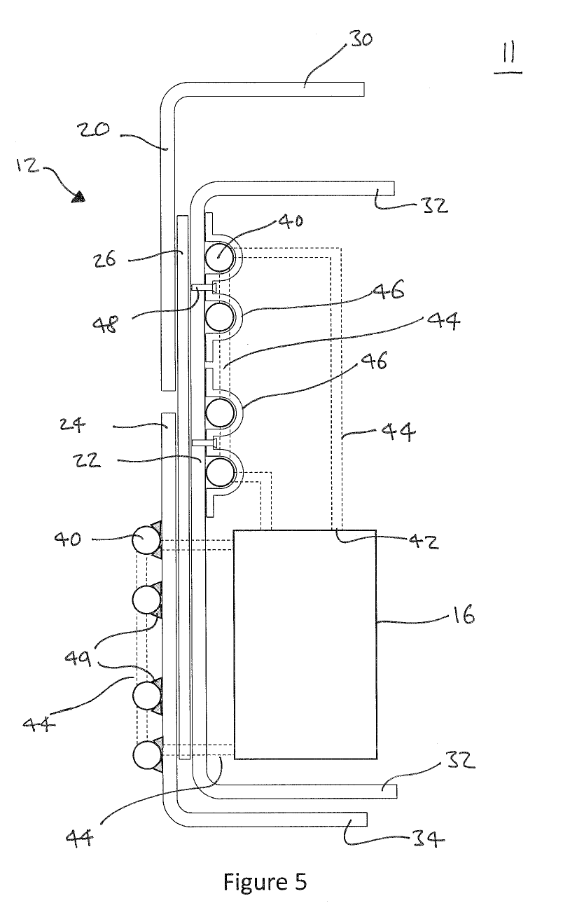

A second example sub-module 11 is partially shown in FIG. 5 in cross section (IGBTs, capacitor not shown). The second example sub-module 11 differs from the sub-module 10 described above in that there are two heat transfer lines 40 provided on each of the respective conductor layers 22, 24 in series with each other. The two heat transfer lines 40 are connected by a further electrically-insulating hose 44 extending therebetween. In other embodiments, the interconnecting hose (or other conduit) and associated connectors could be electrically conducting, as the two heat transfer lines are electrically coupled to the same conductor layer of the busbar.

Accordingly, there are two heat transfer lines electrically and thermally coupled to each of the respective conductor plates 22, 24. The heat transfer lines coupled to the negative plate 22 are electrically insulated from the cooling plate 16 and from the heat transfer lines electrically coupled to the output plate 24.

Further, as shown in FIG. 5 the second example sub-module 11 employs two different manners of connecting the heat transfer lines 40 to the respective conductor layers 20, 24. In particular, a first pair of heat transfer lines 40 are thermally and electrically coupled to the positive plate 20 by respective retaining plates 46 as described above.

A second pair of heat transfer lines 40 are thermally and electrically coupled to the output conductor layer 24 by a welding bead 49 between the respective conductor layer and the heat transfer line 40. In this example, the weld material (or filler material) is similar to the parent material (i.e. the material of the heat transfer lines 40 and the respective conductor layer 24), and is electrically conductive. The weld material may have a lower melting point than the parent material. In other embodiments, the heat transfer lines 40 may be coupled to the respective conductor layer using other metal joining methods, such as braising.

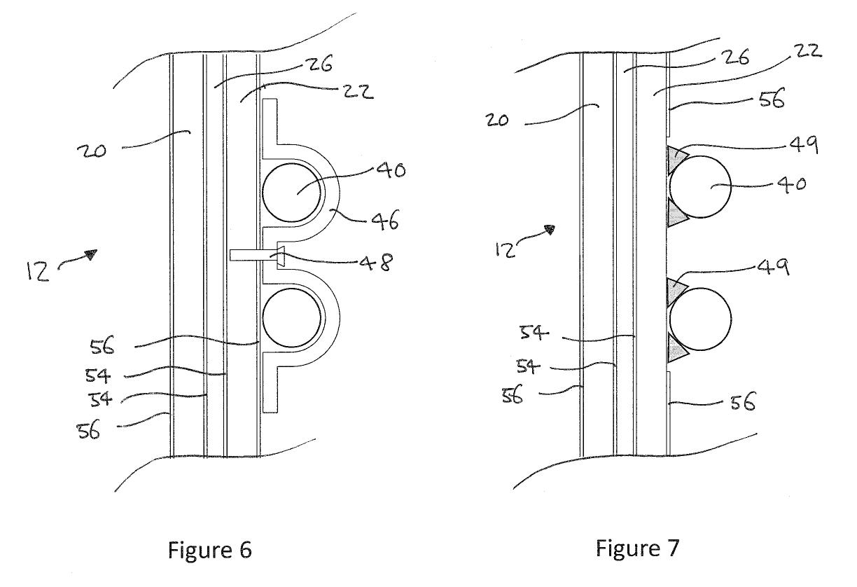

A further example electrical and mechanical connection for a sub-module is shown in FIG. 6, which shows a partial cross-sectional view of a busbar 12 and connected heat transfer lines 40. In this further example, the busbar 12 is manufactured so that there are film layers of electrically insulating material enveloping each conductor layer. In particular, there are film layers 54 disposed between each of the layers of the busbar 12, i.e. between the first and second layers (between the negative layer 22 and the insulator plate 26) and between the second and third layers (the insulator plate 26 and the positive and output layers 20, 24 together). Film layers 56 of insulating material are also provided on the outside surfaces of the conductor layers 20, 22, 24.

Providing the conductor layers 20, 22, 24 of the laminated busbar 12 with the film layer may increase the creepage distance between conductive layers, especially around the terminals of the busbar. In this embodiment, the film layer 54, 56 comprises PET and is approximately 0.1-0.3 mm thick. The film layer is laminated together with the conductor layers, and has substantially the same planar extent as the conductor layers.

In the example shown in FIG. 6, the heat transfer line 40 is not in direct electrical contact with the respective conductor layer 22 as there is an outer film layer 56 between the conductor layer 22 and the heat transfer line 40. However, the heat transfer line 40 is held against the outer film layer 56 by a retaining plate 46 as described above, so as to be thermally coupled with the respective conductor layer through the outer film layer 56. The heat transfer line 40 is electrically coupled with the conductor layer via an electrical pathway through the retaining plate 46 and the fasteners 48, which extend through the outer film layer 56 and into the conductor layer 22 to make a mechanical and electrical connection. The film layer 56 in this embodiment does not serve an electrically insulating function for two reasons. Firstly, the film layer 56 between the heat transfer line 40 and the conductor layer 22 may be insufficiently thick to electrically insulate the conductor layer 22 from the heat transfer line, even though it is composed of an electrically insulating material such as PET. Secondly, the heat transfer line 40 is nevertheless in electrical communication with the conductor layer 22 via the bolt 48.

In other embodiments, a portion of the outer film layer 56 may be absent (i.e. by being removed or not originally applied) in the region of the heat transfer line 40, so that at least a portion of the heat transfer line 40 and/or the retaining plate 46 is in direct electrical contact with the respective conductor layer.

FIG. 7 shows a further example electrical and mechanical connection between a heat transfer line 40 and a conductor layer 22 of a busbar 12 which differs from that shown in FIG. 6 in that the heat transfer line 40 is welded together with the respective conductor layer 22. Further, a portion of the outer film layer 56 over the respective conductor layer 22 is removed prior to welding, or is not applied thereto, so that at least a portion of the heat transfer line 40 (or the welding formations 49) provide an electrical pathway between the respective conductor layer 20 and the heat transfer line. In other embodiments, braising may be used instead of welding.

In other embodiments, the heat transfer line may be welded or brazed to a retaining plate, and the fixing plate may be coupled to the conductor layer as described above.

In one particular example, the heat transfer line may comprise aluminium, and the cooling fluid may comprise de-ionized water (which is compatible with aluminium). When secured to the conductor layer by a retaining plate, the retaining plate may also be made of aluminium.

Connecting the heat transfer lines to the respective conductor layers so that they are both thermally and electrically coupled to the respective conductor layer has the effect that no outer insulating layer between the heat transfer layer and the conductor layer is required. Accordingly, the performance of such an outer layer, which may be affected by high temperature, is not a concern in the design of a busbar assembly (comprising the busbar and associated cooling arrangement) or the corresponding sub-module (or other electrical equipment). Consequently, the heat transfer between the conductive layer and the heat transfer line can be improved because there is no need for an outer layer having a minimum thickness. Further, the benefits of electrically connecting the heat transfer line and the respective conductor layer are still realised when a film layer of insulating material is provided between the heat transfer line and the conductor plate (for example, owing to standard manufacturing practices for the conductor layer/laminated busbar). In particular, such a film layer is redundant for the purposes of electrical insulation, since there is no voltage difference between the heat transfer line and the conductor. Accordingly, the performance of the film layer adjacent the heat transfer line is not a factor in the design of the busbar assembly, and so it is not necessary to limit the current load through the busbar assembly based on the insulating performance of the film layer between the conductor layer and the heat transfer line, nor procure a film layer capable of insulating the heat transfer line from the conductor layer.

In the above described examples, the heat transfer line or lines electrically coupled to a respective conductor layer are electrically insulated from any heat transfer lines electrically coupled to other conductor layers. In the specific examples, the electric insulation is achieved by the electrically-insulating flexible hoses and cooling fluid. Since the cooling fluid is electrically-insulating, the electrically conductive material of the heat transfer line or lines need not be lined with an insulating layer. In particular, the cooling fluid may be in direct contact with the electrically conductive material of the heat transfer line.

In other embodiments, the laminated busbar may comprise fewer than three or more than three conductor layers.

Although embodiments of the invention have been described in which cooling fluid is provided to the heat transfer lines via the cooling plate, in other embodiments the heat transfer lines may be coupled to the cooling source directly or via a distribution manifold, rather than via a cooling plate.

Although embodiments of the invention have been described in which the heat transfer lines are in the form of pipes having a substantially circular cross section, it will be appreciated that in other embodiments, the heat transfer lines may have a different cross section, such as one with at least one flattened (or straight) side for thermal conduction with the respective plate (including square, triangular and semi-circular cross sections).

It will be appreciated that in embodiments of the invention, the conductor layers may not have the same extent and an intermediate conductor layer (i.e. one disposed between at least two other conductor layers) may be exposed in a region where there is no outer conductor layer. Accordingly, a heat transfer line may be thermally and electrically coupled to an intermediate conductor layer.

1. A busbar assembly comprising:
a busbar comprising one or more conductor layers for electrical conduction;
an electrically conductive heat transfer line configured to convey a cooling fluid therethrough, wherein the heat transfer line is thermally and electrically coupled to a conductor layer of the busbar so that in use there is no voltage difference between the heat transfer line and the respective conductor layer of the busbar.

2. The busbar assembly according to claim 1, wherein the heat transfer line is mechanically coupled to the conductor layer.

3. (canceled)

4. The busbar assembly according to claim 2 wherein the heat transfer line is directly mechanically coupled to the conductor layer by braising or welding such that the heat transfer line is continuous with the conductor layer.

5. The busbar assembly according to claim 1, wherein the heat transfer line is mechanically coupled to the conductor layer by a mechanical fastener, and wherein the fastener forms at least part of an electrically conductive pathway between the conductor layer of the busbar and the heat transfer line.

6. The busbar assembly according to claim 5, wherein the mechanical fastener is selected from one of the group consisting of a rivet, stud, screw or bolt.

7. The busbar assembly according to claim 1, wherein the heat transfer line is held against the busbar by an electrically conductive retaining element mechanically and electrically coupled to the conductor layer of the busbar.

8. The busbar assembly according to claim 7, wherein the mechanical fastener extends between the conductor layer and the retaining element.

9. The busbar assembly according to claim 7, wherein the retaining element is in the form of a curved plate.

10. The busbar assembly according to claim 1 wherein the heat transfer line is in the form of a pipe.

11. The busbar assembly according claim 1, wherein the heat transfer line is composed of an electrically conductive material having an electrical conductivity of at least 10⁵ S/m.

12. The busbar assembly according to claim 1, wherein the heat transfer line is composed of a thermally conductive material having a thermal conductivity of at least 12 W/(m.K).

13. The busbar assembly according to claim 1, wherein the heat transfer line is composed of aluminium or stainless steel.

14. The busbar assembly according to claim 1, further comprising:
a film layer of insulating material disposed between at least a portion of the heat transfer line and the respective conductor layer, and
an electrical pathway extending through or around the film layer between the heat transfer line and the respective conductor layer.

15. The busbar assembly according to claim 1, wherein the heat transfer line is coupled to an electrically insulating conduit for attachment to a fluid cooling network, such that in use the conduit electrically insulates the heat transfer line from the fluid cooling network.

16. The busbar assembly according to claim 1, further comprising a fluid cooling network, and wherein the heat transfer line is coupled to the fluid cooling network to receive a cooling fluid from the cooling network.

17. The busbar assembly according to claim 16, wherein the fluid network contains an electrically insulating cooling fluid.

18. (canceled)

19. (canceled)

20. The busbar assembly according to claim 1,
wherein the busbar comprises a plurality of conductor layers; and
wherein there are a plurality of heat transfer lines each heat transfer line being thermally and electrically coupled to one conductor layer only, and wherein at least two conductor layers are thermally and electrically coupled to respective heat transfer lines.

21. The busbar assembly according to claim 1,
wherein the busbar comprises a plurality of conductor layers; and
wherein the plurality of conductor layers comprises at least a first conductor layer and a second conductor layer which are electrically insulated from one another, and wherein the or each heat transfer line electrically coupled with the first conductor layer is electrically insulated from the or each heat transfer line electrically coupled with the second conductor layer.

22. (canceled)

23. A sub-module for a power converter comprising:
a busbar assembly according to claim 1;
a switching element electrically coupled to the busbar of the busbar assembly.

24. A method of power conversion using a sub-module for a power converter in accordance with claim 23, wherein an electrically insulating cooling fluid is provided to the or each heat transfer line.
